(19) United States
(12) Patent Application Publication
(10) Pub. No.: US 2019/0391084 A1
(43) Pub. Date: Dec. 26, 2019

(54) Test Mirror For Gun Care

(71) Applicant: Niebling Technische Bursten GmbH, Burgbernheim (DE)

(72) Inventor: Hans Niebling, Ansbach (DE)

(21) Appl. No.: 16/014,111

(22) Filed: Jun. 21, 2018

(51) Int. Cl. G01N 21/88; F41A 31/02

(52) U.S. Cl. CPC G01N 21/8803; G01N 21/954; F41A 31/02

(57) ABSTRACT

An optical, manually held testing device for firearms with one or more light-reflective mirror surfaces for at least partial insertion into an opening of the firearm. Incident light can be directed into the cavity for checking by eye the completeness of weapon cleaning. The mirror surface or surface area has a narrow and/or elongated shape. As a result, the test device can be held by one hand in the narrow opening of a cartridge chamber or a gun barrel. The narrower the tester, the easier it can be to illuminate inaccessible corners and angles inside the firearm. Because of the elongated shape of the mirror device, the available reflective surface can be made sufficiently large so that sufficient light can be reflected or refracted. By maximizing the amount of mirror surface on the tester, a correspondingly maximized amount of light can be directed into the cavity of the firearm to be examined.

The invention relates to a manually manipulable test mirror for gun care, which has a light-reflecting mirror surface. The invention further relates to an arrangement of a gun and such a test device. Additionally, the invention relates to the use of such a test device with guns.

### BACKGROUND OF THE INVENTION

When a gun is fired, residue and/or fouling are produced inside the gun, for example in the barrel or in the chamber. Guns must therefore be cleaned regularly and then inspected to make sure they are clean. Typically, inspections or searches for damage or dirt particles inside a firearm are carried out visually. In most cases, when a firearm is assembled, its construction prevents a person from viewing the inside of the barrel or the chamber. As a result, damage or dirt particles can go unnoticed, which adversely affects the reliability, safety and longevity of the firearm.

Known from the prior art, therefore, are electronic means, for example, which enable the interior of a firearm that is hidden from view to be inspected. A flashlight from Hoppe's Guncare uses an angled lighting device to illuminate the gun barrel from the inside with a beam of light (https://www.waffenpflege-shop.de/hoppes-bore-light.html, retrieved on 22 Mar. 2018). In addition, MARTI Waffen AG offers an inspection camera with which images from a camera can be transmitted from the end of a connecting cable measuring 4.5 mm in diameter and 1 m in length to a hand-held display held by the user (https://www.waffenmarti.ch/shop/waffenreinigung/waffenreinigung-diverses/produkt/10639-topshot-lauf-inspektionskamera-durchmesser-4-5 mm-1m-laenge.html, retrieved on 22 Mar. 2018).

One disadvantage of this prior art technology is that the test to determine whether the gun barrel and/or the chamber has/have been successfully cleaned requires considerable technical equipment. And this equipment must be carried along on a hunting trip, for example. Furthermore, the dependence on electrical, charged energy storage batteries adversely affects the availability of the test device.

It is therefore an object of the invention to provide a means with which, after cleaning a gun, a user can visually inspect the locations in the gun that are not visible to the naked eye and without auxiliary means.

A further object of the invention is to provide a test means for use after cleaning, which is characterized by high reliability and availability and by a simple design with a minimum number of components and thus by a light weight.

### SUMMARY OF THE INVENTION

The invention is a manually manipulable test mirror for gun care which has one or more light-reflecting mirror surfaces. The mirror surface(s) or a region surrounding or encompassing said surface(s) (mirror surface region) is (are) configured to be inserted at least partially into an opening in the gun, for example an opened chamber. The mirror surface can thereby be placed in an operative optical connection with a hollow space inside the optionally freshly cleaned gun to illuminate the hollow space, for example the barrel bore. Light that strikes the mirror surface, for example daylight or light from a flashlight or some other external light source, can be directed into the hollow space, which is thereby illuminated. At the other end of the hollow space, for example at the open end of the barrel, the gun user can visually inspect the weapon for cleanliness. A test device of this type may serve as a supplement to cleaning and care kits for guns.

The configuration of the mirror surface or the mirror surface region with a slender and/or elongated shape is particularly advantageous. This enables the test device to be held in the narrow opening of a chamber or a gun barrel. The slimmer the test device is, the more easily it can be used to illuminate inaccessible corners and angles inside the gun. Moreover, due to the elongated shape of the mirror device, the available reflective surface is large enough to reflect or deflect sufficient ambient light or daylight. By maximizing the amount of mirror surface on the test device, a correspondingly maximized quantity of daylight or light generated by an external light source can be directed into the hollow space of the gun to be examined.

An exemplary, particularly simple embodiment of the invention consists in the implementation thereof as a preferably single-piece mirror rod, in which a carrier body in the form of a rod includes the structurally integrated mirror surface. The mirror rod is expediently configured as having a cuboid or other prismatic shape, which results in a substantially flat longitudinal side for an effective mirror surface, without optical distortions in the mirror effect.

In another exemplary embodiment, the one or more mirror surfaces are recessed or embedded in a frame body, or are encompassed, bordered, surrounded, or held therein, and are thereby protected by said frame body. One longitudinal side of the frame is open toward the mirror surface, for example slotted. Expediently, the mirror surface is an integrated component of a mirror substrate (mirror surface carrier body).

According to one aspect of the invention, the device frame is subdivided into a handle portion and a mirror portion, with the mirror substrate being situated exclusively in the mirror portion. The attachment of a hanging eye or some other fastening element, preferably at the unattached end region of the handle portion, facilitates hanging and fastening of the test device on external transport and holding devices.

The reflective surface or mirror surface may be the surface of the mirror substrate itself or may form an inner layer within the mirror substrate. The mirror portion and the handle portion may be integral parts of the preferably single-piece frame. The frame may be cast (for example by a plastic injection molding process) and/or milled. An end-face frame opening, through which the mirror substrate can be moved longitudinally into and out of the frame, makes it possible to replace mirror substrates when the mirror surfaces thereof become soiled or damaged. This makes use of a particular aspect of the invention, according to which the frame is configured as a hollow rail that is open on one longitudinal side, and the mirror substrate can be inserted into and removed from the cavity in said hollow rail and can be held therein by way of friction. Alternatively or additionally, the mirror substrate may be inserted from above, i.e. for example through the longitudinal opening in the hollow rail, into the receiving groove in the frame, and fastened therein by gluing. For this purpose, at least one boundary wall of the hollow rail or one contact wall between the hollow rail and the mirror substrate has an adhesive layer for producing an adhesive bond with the mirror substrate.

Independent intellectual property protection is further claimed for a testing arrangement that includes a gun and an optical test device having at least one light-reflecting mirror surface, wherein the mirror surface is inserted at least partially into a gun opening and is placed in operative optical connection with a bore or some other hollow space of the gun, for the illumination of said hollow space with daylight or with an artificial light source. The scope of the invention further includes the use of a test device having a mirror surface to illuminate the interior of a gun, in particular a gun barrel and/or chamber, with ambient light or with other light deflected and/or reflected by the mirror surface.

In a preferred refinement of such use, the test device is rotated, preferably about a symmetry axis and/or center axis, to illuminate the interior of the gun, in particular the gun barrel and/or the chamber. In this way, both the barrel bore and the chamber can be illuminated up to all boundary walls.

### BRIEF LISTING OF FIGURES

FIG. 1a is a perspective diagram of an exemplary test device according to the invention,

FIG. 1b shows a perspective view of the test device according to FIG. 1a,

FIG. 2 shows a frontal/end-face view of the test device,

FIG. 3 shows a perspective diagram of an exemplary use of the test device in an arrangement on a gun, and

FIGS. 4a and 4b each show a further exemplary embodiment of a test device according to the invention having an adhesive bond, from a frontal/end-face view,

FIGS. 5 and 6 show corresponding perspective diagrams of additional exemplary embodiments of a test device according to the invention.

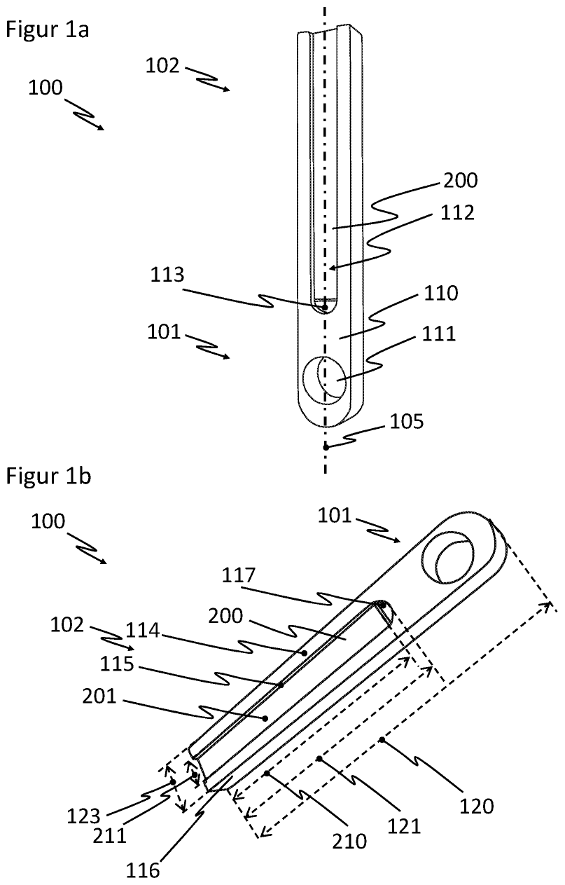

According to FIG. 1a, test device 100 comprises a first portion or handle portion 101 and immediately adjoining the first portion, a second portion or mirror portion 102, which is longer than handle portion 101, for example two to three times as long. The two portions 101, 102 are components of a single-piece frame 110, for example made of plastic. At the end region of handle portion 101, test device 100 is provided with a fastening element, for example a hanging eye 111 that extends through the frame, to enable test device 100 to be attached to a belt or to a keychain, for example via a carabiner or a tab.

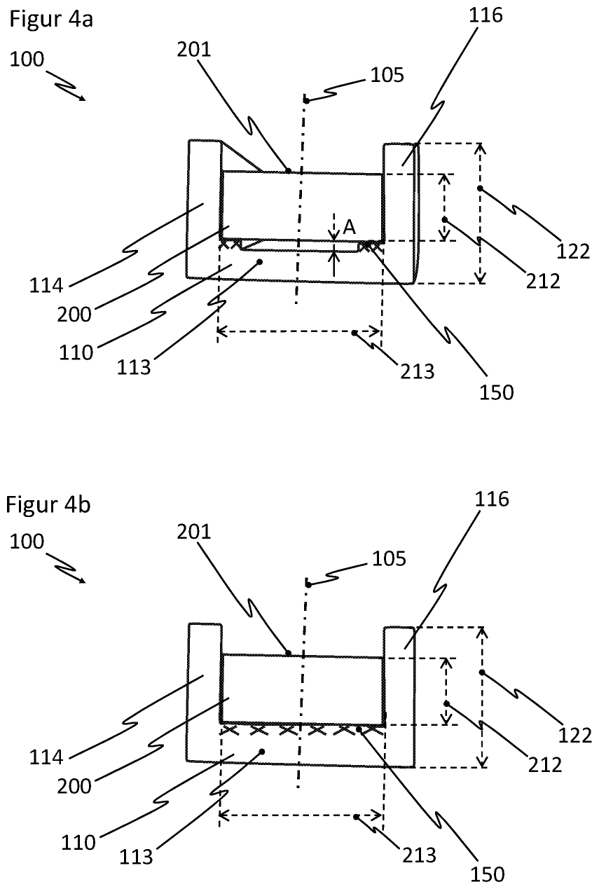

The mirror portion 102 of frame 110 is configured as a hollow rail having a U-like profile in cross-section, with the resulting cavity being usable as a receiving groove 112 for receiving a mirror substrate 200 with mirror surface 201. Ambient light 500 (cf., FIG. 3) can be deflected or reflected by this mirror surface 201. Hanging eye 111 and/or receiving groove 112 may be formed by machining the blank for frame 110, for example. The embodiment depicted in FIGS. 1a, 1b, 2, 4a and 4b is configured as axially symmetrical along a longitudinal center axis 105 (cf., FIG. 1a) and/or a transverse center axis 105a (cf., FIG. 4). However, depending on the shape of the interior 302 of a gun 300 (cf., FIG. 3), asymmetrical embodiments may also be advantageous.

FIG. 1b shows the test device 100 depicted in FIG. 1a from a second perspective. Test device 100 is elongated or oblong and slender in configuration, in that its total width 123, for example at 10 mm, is equal to almost 15% of its total length 120, which is 70 mm, for example. This total width 123, chosen by way of example, allows test device 100 to be inserted into a chamber 301 (cf., FIG. 3), which typically has an opening of 20 mm, and to be moved therein freely or at least with a certain amount of clearance. Mirror surface 201 of mirror substrate 200 is also configured as oblong or elongated with a mirror width 211 of 5 mm, for example, which is almost 10% of the total mirror length 210 of 48 mm, for example. As a result, despite the correspondingly slender configuration of mirror surface 201, sufficient ambient light 500 (cf., FIG. 3) can still be deflected and/or reflected.

Mirror substrate 200 with mirror surface 201 is recessed in mirror portion 102 of frame 110 and is held on its opposing longitudinal sides by a first profile arm 114 and a second profile arm 116. The first profile arm 114 and the second profile arm 116, together with a center bridge 113 connecting these arms, form a cross-sectionally U-shaped hollow rail with the receiving groove 112 formed therein (cf., FIG. 1a) and with a hollow rail length 121 that exceeds the total mirror length 210 by an open width 117 (cf., FIG. 1b).

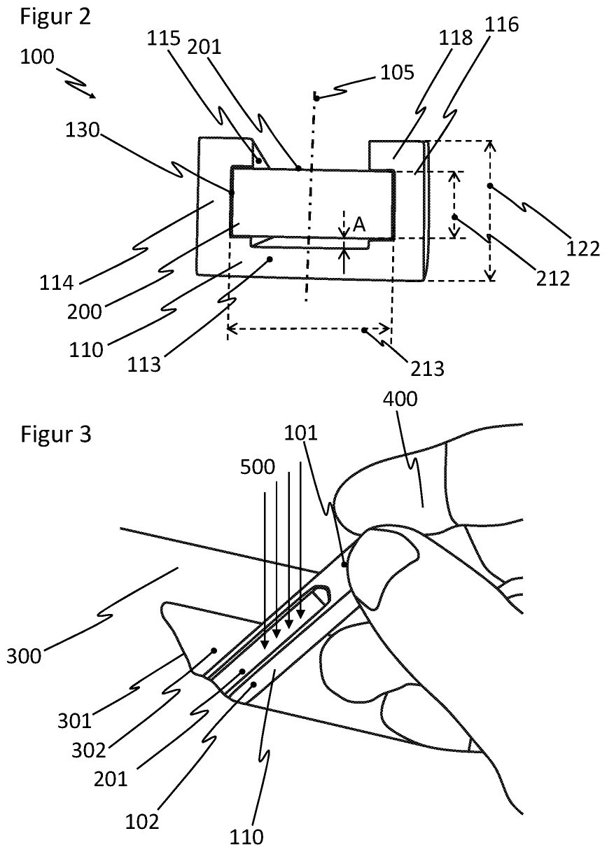

To hold mirror substrate 200 in receiving groove 112 of the hollow rail, an inner wall groove 130 (cf., FIG. 2), into which mirror substrate 200 can be inserted and held frictionally and/or positively, can be formed on each of the inner walls 115 of a profile arm 114, 116. As a result, unattached, inwardly bent arm ends 118 are produced on profile arms 114, 116, enabling additional encompassing of mirror body 200.

Provided the length 121 of receiving groove 112 is dimensioned with an additional tolerance relative to total mirror length 210, the open width 117 at the inner end of receiving groove 112 can be realized. According to one exemplary embodiment, the length of the receiving groove is 50 mm. Open width 117 can be used for replacing mirror substrate 200 if mirror surface 201 becomes soiled, for example, by inserting a tool, e.g. a screwdriver, into open width 117 and then bracing the tool against an end edge of receiving groove 112 in the manner of a lever, so that the mirror substrate can be forced (“pried”) out of receiving groove 112.

According to FIG. 2, each of the inner wall grooves 130 is disposed offset vertically from center bridge 113 of the hollow rail U-profile, so that for mirror substrate 201, which is held preferably frictionally in the inner wall grooves 130, a distance A from center bridge 113 results, which forms the bottom of the receiving groove 112. The resulting open space between mirror substrate 200 and center bridge 113 reduces the frictional forces that occur during displacement of mirror substrate 200, and thereby facilitates the insertion and removal of mirror substrate 200 into and out of receiving groove 112.

FIG. 2 shows the end face of test device 100 that closes off mirror portion 102 (cf., FIG. 1a). The two inner wall grooves 130 encompass the entire mirror width 213 of mirror device 200 symmetrically to transverse center axis 105 and/or transverse symmetry axis 105a, holding said mirror device in a largely positive or at least frictional manner. The remaining open region that is visible from the outside then reveals the mirror surface 201 on or in mirror substrate 200. Mirror substrate 200 is expediently made of glass and/or metal and/or some other reflective material. The width of an inner wall groove 130 is equal to the height or the total mirror depth 212 of mirror substrate 200. Here, the total mirror depth 212 is 3 mm, for example, while the total depth 122 of test device 100 may be between 5 and 6 mm.

FIG. 3 shows an example of the use of a test device 100 for inspecting the cleaning of a gun 300 once cleaning has been completed. An operator or user 400 grips test device 100 manually on the first portion or handle portion 101. The second portion or mirror portion 102 is held in the chamber 301, with ambient light 500 being reflected and/or deflected on mirror surface 201, thereby illuminating an interior region 302 of chamber 301 or gun 300 or the barrel bore of the gun. The dimensions of test device 100 as chosen above by way of example enable the user 400 to align the mirror surface 201 on all sides in chamber 301 and thus fully illuminate the interior 302 of gun 300 with ambient light. Frame 110 prevents any undesirable contact between mirror surface 201 and gun 300 and thus protects mirror surface 201 against damage and/or soiling. A test device 100 according to the invention may have an average universal size, making it usable with all common small-caliber and large-caliber firearms.

FIG. 4a shows a perspective diagram of an embodiment of test mirror 100, in which the inwardly bent arm ends 118 of profile arms 114, 116 for encompassing mirror substrate 200 have been omitted. To hold mirror substrate 200 in frame 110, one or more contact walls between frame 110 and mirror substrate 200 are equipped with one or more adhesive layers 150. FIG. 4b shows a schematic frontal view of a further simplified embodiment of test mirror 100, in which the distance A between mirror substrate 200 and center bridge 113 has been omitted. This further simplifies manufacturing of the frame 110, while at the same time allowing an adhesive layer 150 to be applied on or to a large area of center bridge 113, to create a secure bond between frame 110 and mirror substrate 200. In the embodiments depicted in FIGS. 4a and 4b, the end-face opening in the hollow rail can be dispensed with, in which case the mirror substrate 200 is fully encompassed and preferably positively held on the mirror substrate side walls 202 by frame 110.

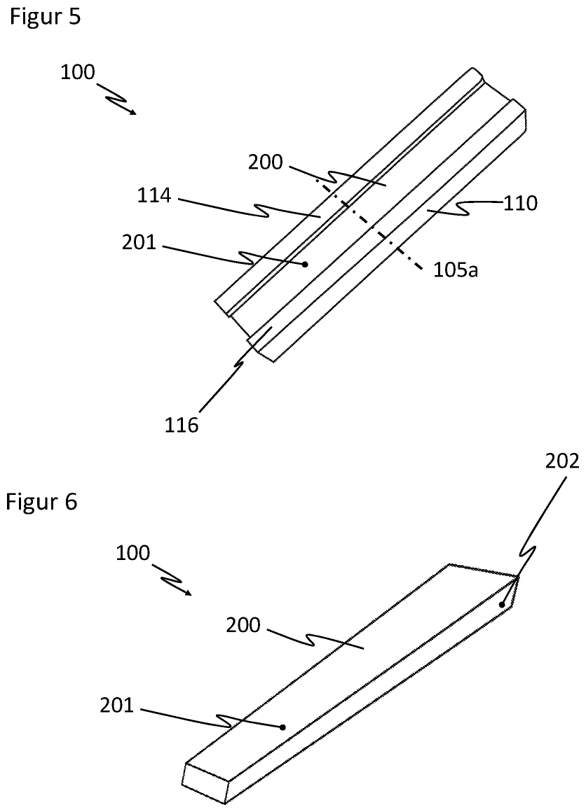

In an alternative, structurally simplified embodiment of the invention according to FIG. 5, test device 100 is without a separate handle portion 101 (cf., FIG. 1a). Instead, frame 110 comprises only a mirror portion 102 (cf., FIG. 1a) in the form of a hollow rail with a cross-sectionally U-like profile in the manner described above (cf., FIGS. 2, 4a, 4b), said mirror portion being held on its opposing longitudinal sides by a first profile arm 114 and a second profile arm 116. As a result, mirror surface 201 of mirror substrate 200 is configured with the maximum possible longitudinal extension with respect to frame 110. When using test device 100, an operator or user 400 (cf., FIG. 3) would grip the device manually on the sides of profile arms 114, 116, for example.

In a further alternative, structurally further simplified embodiment of the invention according to FIG. 6, test device 100 has no frame 110. Instead, test device 100 comprises an oblong, for example cuboid, mirror substrate 200 having a rectangular mirror surface 201. Depending on the geometry of the interior region 302 of chamber 301 or of gun 300 (cf., FIG. 3) or of the gun barrel bore, mirror substrate 200 may also comprise conical or prismatic geometries. When using test device 100, an operator or user 400 (cf., FIG. 3) would grip the device or mirror substrate 200 manually on the sides of mirror substrate side walls 202, for example.

### LIST OF REFERENCE SIGNS

100 test device
101 first portion, handle portion
102 second portion, mirror portion
105 longitudinal center axis/symmetry axis
105a transverse center axis/symmetry axis
110 frame
111 hanging eye
112 receiving groove
113 center bridge
114 first profile arm
115 inner wall
116 second profile arm
117 open width
118 bent arm end
120 total length
121 receiving rail length
122 total depth
123 total width
130 inner wall groove
150 adhesive layer
200 mirror substrate
201 mirror surface
202 mirror substrate side wall
210 total mirror length
211 mirror surface width
212 total mirror depth
213 total mirror width
300 gun
301 chamber
302 interior region
400 user
500 ambient light/daylight
A distance

1. An optical, manually manipulable test device (100) for guns, having at least one light-reflecting mirror surface (201), the mirror surface (201) or at least one mirror surface region surrounding or encompassing the mirror surface (201) being configured such that the mirror surface (201) can be inserted through a gun opening (301) and placed in operative optical connection with a hollow space inside the gun that can be viewed from the outside, for the purpose of illuminating said hollow space.

2. The test device (100) of claim 1, wherein the mirror surface (201) or the mirror surface region is configured with a slender or elongated shape to enable the mirror surface (201) to be inserted at least partially into a gun opening (301).

3. The test device (100) of claim 1, wherein in the mirror surface (201) or in the mirror surface region, the ratio of width to length ranges from 1:2 to 1:50, or from 1:5 to 1:15, or from 1:8 to 1:12, or is 1:10.

4. The test device (100) of claim 1 having an oblong frame (110), open or slotted toward the mirror surface (201) on at least one longitudinal side, in which a mirror substrate (200) that includes the mirror surface (201) is held.

5. The test device (100) of claim 4, wherein the frame (110) is made of plastic or by means of an injection molding process.

6. The test device (100) of claim 4, wherein the frame (110) is configured as a hollow rail open on one longitudinal side, with the mirror substrate (200) being held positively or frictionally in a cavity in said hollow rail.

7. The test device (100) of claim 4, wherein the frame (110) is configured as a hollow rail open on one longitudinal side, with the mirror substrate (200) being held by an adhesive layer (150) in a cavity in said hollow rail.

8. The test device (100) of claim 4, wherein the mirror substrate (200) has an oblong shape or a cuboid shape.

9. The test device (100) of claim 6, wherein one end face of the hollow rail has an opening, through which the mirror substrate (200) can be inserted into or removed from the hollow rail.

10. The test device (100) of claim 6, wherein the hollow rail is configured with a cross-sectionally U-shaped profile having opposing profile arms (114, 116).

11. The test device (100) of claim 10, wherein a mirror substrate (200) held frictionally between the mutually facing inner surfaces of the opposing profile arms (114, 116) can be moved slidingly along said inner surfaces.

12. The test device (100) of claim 10, wherein unattached arm ends (118) of the one or more profile arms (114, 116) are bent, inclined or angled inwardly toward the cavity in the hollow rail, wherein the bent, inclined or angled arm end(s) (118) delimit an opening in the longitudinal side of the hollow rail that allows light (500) to strike the mirror surface, and encompass, enclose or hold the mirror substrate (200).

13. The test device (100) of claim 10, wherein the mirror substrate (200) is disposed at a distance (A) from a center bridge (113) of the U-like hollow rail profile that connects the two profile arms (114, 116).

14. The test device (100) of claim 11, wherein on the inner side or inner wall of the profile arm, an inner wall groove (130) or some other inner wall recess is formed, the configuration of which is adapted to the shape of the mirror substrate (200) for the purpose of holding at least the longitudinal side edge or mirror substrate side wall (202) of said mirror substrate in a positive or frictional connection.

15. The test device (100) of claim 14, wherein the inner wall groove (130) or some other inner wall recess extends at a distance (A) or with a vertical offset from the profile center bridge (113).

16. The test device (100) of claim 4, wherein the frame (110) has a handle portion (101) and a mirror portion (102), wherein the mirror substrate (200) extends exclusively in the mirror portion (102).

17. The test device (100) of claim 16, wherein the handle portion (101) is penetrated by a bore, to form a hanging eye (111) or some other fastening element, such as a hook.

18. The test device (100) of claim 1, wherein the total width (123) of the test device (100) is 5-30% or 10-20% of the total length (120) of the test device (100).

19. The test device (100) of claim 1, wherein the width (211) of the mirror surface (201) is 5-30% or 10-20% of the total length (210) of the mirror surface (201).

20. The test device (100) of claim 16, wherein the total length (210) of the mirror surface (201) or of the mirror portion is at least 30% or at least 50% or at least 70% of the total length (120) of the test device (100).

21. The test device (100) of claim 1, embodied as a mirror in the form of a rod, which forms a support body in or with which the mirror surface (201) or the mirror surface region is structurally integrated.

22. A gun testing arrangement comprising a gun (300) and an optical test device (100) having at least one light-reflecting mirror surface (201), which is inserted at least partially into a gun opening and is placed in operative optical connection with a bore or hollow space in the gun (300) to illuminate said bore or hollow space with daylight (500) or with light from an artificial light source.

23. The testing arrangement of claim 22, wherein the test device (100) is inserted at least partially into a chamber (301) of the gun (300).

24. The testing arrangement of claim 22, wherein the test device (100) is inserted into the opening with clearance or is movable in the opening.

25. A use of a test device (100) having a mirror surface (201) to illuminate a bore or a hollow space in a gun (300), in which the test device (100) is held with the mirror surface (201) at an opening or an open inlet or outlet of the bore or hollow space such that light (500) striking the mirror surface (201) is reflected into the bore or the hollow space.

26. The use of claim 25, wherein the test device (100) is held with the mirror surface (201) inside the open chamber (301) of the gun (300).

27. The use of claim 25, wherein the test device (100) held inside the opening or inside a chamber (301) of the gun (300) is rotated or otherwise moved therein so as fully illuminate a barrel bore that is connected to the chamber (301).
